(19) United States
(12) Patent Application Publication
(10) Pub. No.: US 2022/0186153 A1
(43) Pub. Date: Jun. 16, 2022

(54) LAUNDRY DETERGENT COMPOSITIONS

(71) Applicant: CONOPCO, INC., D/B/A UNILEVER, Englewood Cliffs, NJ (US)

(72) Inventors: Paul FERGUSON, Bebington, Wirral Merseyside (GB); Adam Peter JARVIS, Bebington, Wirral Merseyside (GB); Christopher Clarkson JONES, Bebington, Wirral Merseyside (GB); Andrew Philip PARKER, Bebington, Wirral Merseyside (GB)

(73) Assignee: CONOPCO, INC., D/B/A UNILEVER, Englewood Cliffs, NJ (US)

(21) Appl. No.: 17/442,241

(22) PCT Filed: Mar. 18, 2020
(86) PCT No.: PCT/EP2020/057482

§ 371 Date: Sep. 23, 2021

(30) Foreign Application Priority Data
Mar. 28, 2019 (EP) 19166000.0

(51) Int. Cl. C11D 3/50; C11D 11/00; C11D 3/22; C11D 3/37; C11D 17/00

(52) U.S. Cl. CPC C11D 3/505; C11D 11/0017; C11D 17/0013; C11D 3/3765; C11D 3/225

(57) ABSTRACT

The invention provides a liquid laundry detergent composition having:

(i) an aqueous continuous phase including from 3 to 80% (by weight based on the total weight of the composition) of one or more detersive surfactants and from 0.05% to 2% (by weight based on the total weight of the composition) of a first polymeric rheology modifier; and
(ii) a dispersed phase of suspended benefit agent delivery particles; the particles having a core-shell structure in which a shell of polymeric material entraps a core containing the benefit agent;
in which a second polymeric rheology modifier comprises a hydrophilic polysaccharide backbone and is covalently attached to the exterior surface of the shell of the delivery particle (either directly or via a linking group);
and in which the first and the second polymeric rheology modifiers each have a hydrophilic backbone including at least one hydrophobic segment which is available to form non-specific hydrophobic associations within the composition.

The present invention relates to liquid laundry detergent compositions having a dispersed phase of suspended benefit agent delivery particles.

In laundry treatment compositions such as laundry detergents, the fragrance experienced by consumers is one of the most important attributes. Efficient delivery of the right fragrances to the fabric during the laundry process and release of that fragrance at key consumer moments is critical to the delivery of clean and fresh laundry.

The delivery of fragrance at key moments is a difficult task. Fragrance molecules are typically oily materials, and laundry detergents are usually designed to carry oily materials away from the laundered fabric. After washing comes drying, often by heating, and fragrance molecules tend to evaporate in the process.

Fragrance encapsulation is one technique which has been successfully deployed in powdered laundry detergents to deliver long-lasting fragrance benefits to fabrics. The encapsulating polymer is typically a thin, flexible membrane surrounding a fragrance droplet and helping to make sure that it is carried across all stages of product use.

However, liquid formulations are rapidly becoming a preferred format for laundry detergents. One problem encountered with the production of liquid laundry detergents containing encapsulates is the tendency of the encapsulates to phase separate or precipitate out of the liquid formulation during transportation or extended storage.

WO2015/155286 describes how external structurants may be used to impart suspending capability to liquid laundry detergents whilst maintaining ‘pourable’ flow characteristics. The external structurant sits within the liquid formulation as a framework and increases viscosity by constraining the continuous phase but has minimal interaction with the formulation ingredients. External structuring is typically mediated by fibrous or crystalline materials such as citrus pulp or hydrogenated castor oil (HCO); but may alternatively make use of colloidal particles such as clay.

A drawback of many external structurants is their need for special processing conditions, for example involving the use of structurant premixes incorporating large amounts of water. Such structurant premixes are less suitable for compact detergents and for unit-dose applications. In addition, many external structurants have to be used in high amounts in order to provide the desired structuring effect.

It would be desirable to reduce the amount of such external structurants in a liquid laundry detergent, whilst still providing good product stability, as well as effective delivery of benefit agents to substrates such as cotton and polyester.

The present invention addresses this problem.

The invention provides a liquid laundry detergent composition having:

(i) an aqueous continuous phase including from 3 to 80% (by weight based on the total weight of the composition) of one or more detersive surfactants and from 0.05% to 2% (by weight based on the total weight of the composition) of a first polymeric rheology modifier; and

(ii) a dispersed phase of suspended benefit agent delivery particles; the particles having a core-shell structure in which a shell of polymeric material entraps a core containing the benefit agent;

in which a second polymeric rheology modifier comprises a hydrophilic polysaccharide backbone and is covalently attached to the exterior surface of the shell of the delivery particle (either directly or via a linking group);

and in which the first and the second polymeric rheology modifiers each have a hydrophilic backbone including at least one hydrophobic segment which is available to form non-specific hydrophobic associations within the composition.

The term “detergent composition” in the context of this invention denotes formulated compositions intended for and capable of wetting and cleaning domestic laundry such as clothing, linens and other household textiles. The term “linen” is often used to describe certain types of laundry items including bed sheets, pillow cases, towels, tablecloths, table napkins and uniforms. Textiles can include woven fabrics, non-woven fabrics, and knitted fabrics; and can include natural or synthetic fibres such as silk fibres, linen fibres, cotton fibres, polyester fibres, polyamide fibres such as nylon, acrylic fibres, acetate fibres, and blends thereof including cotton and polyester blends.

As used herein, “associative” means a linkage between the hydrophobic segment and any part of the composition without covalent bonding. Associative may include physical retention, such as entanglement or anchoring, or hydrogen bonding, van der Waals forces, dipole-dipole interactions, electrostatic attraction, and combinations of these effects.

The term “monomer” or “monomeric unit” is used herein to refer to a polymer building block which has a defined molecular structure and which can be reacted to form a part of a polymer. It will be understood that these terms refer to the minimum repeating unit when any reactive side chain precursor group present is taken into consideration.

A “polymer” is a substance composed of molecules characterized by the multiple repetitions of one or more species of atoms or groups of atoms (“monomers” as constitutional units) linked to each other in amounts sufficient to provide a set of properties that do not vary markedly with the addition or removal of one or a few constitutional units. (IUPAC definition, see E. S. White, J. Chem. Inf. Comput. Sci. 1997, 37, 171-192). A polymer molecule can be thought of in terms of its “backbone”, the connected link of atoms that span the length of the molecule, and the “pendant” groups, attached to the backbone portion of each constituent unit. The pendant groups may be chemically and functionally different from the backbone chain.

As used herein “segment” or “block” means a moiety which has a structure comprising repeating units preferably with similar properties such as composition or hydrophobicity.

Examples of detergent compositions include heavy-duty detergents for use in the wash cycle of automatic washing machines, as well as fine wash and colour care detergents such as those suitable for washing delicate garments (e.g. those made of silk or wool) either by hand or in the wash cycle of automatic washing machines.

The viscosity of the composition of this invention may suitably range from about 200 to about 10,000 mPa·s at 25° C. at a shear rate of 21 sec⁻¹. This shear rate is the shear rate that is usually exerted on the liquid when poured from a bottle. Pourable liquid compositions generally have a viscosity of from 200 to 2,500 mPa·s, preferably from 200 to 1500 mPa·s. Liquid compositions which are pourable gels generally have a viscosity of from 1,500 mPa·s to 6,000 mPa·s, preferably from 1,500 mPa·s to 2,000 mPa·s.

The composition of the invention has an aqueous continuous phase, and will generally comprise from 5 to 95%, preferably from 10 to 90%, more preferably from 15 to 85% water (by weight based on the total weight of the composition). The composition may also incorporate non-aqueous carriers such as hydrotropes, co-solvents and phase stabilizers. Such materials are typically low molecular weight, water-soluble or water-miscible organic liquids such as C1 to C5 monohydric alcohols (such as ethanol and n- or i-propanol); C2 to C6 diols (such as monopropylene glycol and dipropylene glycol); C3 to C9 triols (such as glycerol); polyethylene glycols having a weight average molecular weight (M_{w}) ranging from about 200 to 600; C1 to C3 alkanolamines such as mono-, di- and triethanolamines; and alkyl aryl sulfonates having up to 3 carbon atoms in the lower alkyl group (such as the sodium and potassium xylene, toluene, ethylbenzene and isopropyl benzene (cumene) sulfonates).

Mixtures of any of the above described materials may also be used.

Non-aqueous carriers, when included in a composition according to the invention, may be present in an amount ranging from 0.1 to 20%, preferably from 1 to 15%, and more preferably from 3 to 12% (by weight based on the total weight of the composition).

The composition of the invention preferably has a pH in the range of 5 to 9, more preferably 6 to 8, when measured on dilution of the composition to 1% using demineralised water.

The aqueous continuous phase of the composition of the invention includes from 3 to 80% (by weight based on the total weight of the composition) of one or more detersive surfactants.

The term “detersive surfactant” in the context of this invention denotes a surfactant which provides a detersive (i.e. cleaning) effect to laundry treated as part of a domestic laundering process.

The choice of detersive surfactant, and the amount present, will depend on the intended use of the composition. For example, different surfactant systems may be chosen for hand-washing products and for products intended for use in different types of automatic washing machine. The total amount of detersive surfactant present will also depend on the intended end use. In compositions for machine washing of fabrics, an amount of from 5 to 40%, such as 7 to 35% (by weight based on the total weight of the composition) is generally appropriate. Higher levels may be used in compositions for washing fabrics by hand, such as up to 60% (by weight based on the total weight of the composition.

Preferred detersive surfactants may be selected from non-soap anionic surfactants, nonionic surfactants and mixtures thereof.

Non-soap anionic surfactants are principally used to facilitate particulate soil removal. Non-soap anionic surfactants for use in the invention are typically salts of organic sulfates and sulfonates having alkyl radicals containing from about 8 to about 22 carbon atoms, the term “alkyl” being used to include the alkyl portion of higher acyl radicals. Examples of such materials include alkyl sulfates, alkyl ether sulfates, alkaryl sulfonates, alpha-olefin sulfonates and mixtures thereof. The alkyl radicals preferably contain from 10 to 18 carbon atoms and may be unsaturated. The alkyl ether sulfates may contain from one to ten ethylene oxide or propylene oxide units per molecule, and preferably contain one to three ethylene oxide units per molecule. The counterion for anionic surfactants is generally an alkali metal such as sodium or potassium; or an ammoniacal counterion such as monoethanolamine, (MEA) diethanolamine (DEA) or triethanolamine (TEA). Mixtures of such counterions may also be employed.

A preferred class of non-soap anionic surfactant for use in the invention includes alkylbenzene sulfonates, particularly linear alkylbenzene sulfonates (LAS) with an alkyl chain length of from 10 to 18 carbon atoms. Commercial LAS is a mixture of closely related isomers and homologues alkyl chain homologues, each containing an aromatic ring sulfonated at the “para” position and attached to a linear alkyl chain at any position except the terminal carbons. The linear alkyl chain typically has a chain length of from 11 to 15 carbon atoms, with the predominant materials having a chain length of about C12. Each alkyl chain homologue consists of a mixture of all the possible sulfophenyl isomers except for the 1-phenyl isomer. LAS is normally formulated into compositions in acid (i.e. HLAS) form and then at least partially neutralized in-situ.

Also suitable are alkyl ether sulfates having a straight or branched chain alkyl group having 10 to 18, more preferably 12 to 14 carbon atoms and containing an average of 1 to 3EO units per molecule. A preferred example is sodium lauryl ether sulfate (SLES) in which the predominantly C12 lauryl alkyl group has been ethoxylated with an average of 3EO units per molecule.

Some alkyl sulfate surfactant (PAS) may be used, such as non-ethoxylated primary and secondary alkyl sulphates with an alkyl chain length of from 10 to 18.

Mixtures of any of the above described materials may also be used. A preferred mixture of non-soap anionic surfactants for use in the invention comprises linear alkylbenzene sulfonate (preferably C₁₁ to C₁₅ linear alkyl benzene sulfonate) and sodium lauryl ether sulfate (preferably C₁₀ to C₁₈ alkyl sulfate ethoxylated with an average of 1 to 3 EO). In a composition according to the invention, the total level of non-soap anionic surfactant may suitably range from 3 to 20% (by weight based on the total weight of the composition).

Nonionic surfactants may provide enhanced performance for removing very hydrophobic oily soil and for cleaning hydrophobic polyester and polyester/cotton blend fabrics. Nonionic surfactants for use in the invention are typically polyoxyalkylene compounds, i.e. the reaction product of alkylene oxides (such as ethylene oxide or propylene oxide or mixtures thereof) with starter molecules having a hydrophobic group and a reactive hydrogen atom which is reactive with the alkylene oxide. Such starter molecules include alcohols, acids, amides or alkyl phenols. Where the starter molecule is an alcohol, the reaction product is known as an alcohol alkoxylate. The polyoxyalkylene compounds can have a variety of block and heteric (random) structures. For example, they can comprise a single block of alkylene oxide, or they can be diblock alkoxylates or triblock alkoxylates. Within the block structures, the blocks can be all ethylene oxide or all propylene oxide, or the blocks can contain a heteric mixture of alkylene oxides. Examples of such materials include aliphatic alcohol ethoxylates such as C₈ to C₁₈ primary or secondary linear or branched alcohol ethoxylates with an average of from 2 to 40 moles of ethylene oxide per mole of alcohol.

A preferred class of nonionic surfactant for use in the invention includes aliphatic C₈ to C₁₈, more preferably C₁₂ to C₁₅ primary linear alcohol ethoxylates with an average of from 3 to 20, more preferably from 5 to 10 moles of ethylene oxide per mole of alcohol.

Mixtures of any of the above described materials may also be used.

Nonionic surfactant, when included, will preferably be present in an amount ranging from 0.1 to 5% (by weight based on the total weight of the composition).

A composition of the invention may optionally contain one or more cosurfactants (such as amphoteric (zwitterionic) and/or cationic surfactants) in addition to the non-soap anionic and/or nonionic detersive surfactants described above.

Specific cationic surfactants include C₈ to O₁₈ alkyl dimethyl ammonium halides and derivatives thereof in which one or two hydroxyethyl groups replace one or two of the methyl groups, and mixtures thereof. Cationic surfactant, when included, may be present in an amount ranging from 0.1 to 5% (by weight based on the total weight of the composition).

Specific amphoteric (zwitterionic) surfactants include alkyl amine oxides, alkyl betaines, alkyl amidopropyl betaines, alkyl sulfobetaines (sultaines), alkyl glycinates, alkyl carboxyglycinates, alkyl amphoacetates, alkyl amphopropionates, alkylamphoglycinates, alkyl amidopropyl hydroxysultaines, acyl taurates and acyl glutamates, having alkyl radicals containing from about 8 to about 22 carbon atoms, the term “alkyl” being used to include the alkyl portion of higher acyl radicals. Amphoteric (zwitterionic) surfactant, when included, may be present in an amount ranging from 0.1 to 5% (by weight based on the total weight of the composition).

A composition of the invention may suitably comprise from 0.1 to 10% (by weight based on the total weight of the composition) of polymeric cleaning boosters selected from antiredeposition polymers, soil release polymers and mixtures thereof.

SRPs help to improve the detachment of soils from fabric by modifying the fabric surface during washing. The adsorption of a SRP over the fabric surface is promoted by an affinity between the chemical structure of the SRP and the target fibre.

SRPs for use in the invention may include a variety of charged (e.g. anionic) as well as non-charged monomer units and structures may be linear, branched or star-shaped. The SRP structure may also include capping groups to control molecular weight or to alter polymer properties such as surface activity. The weight average molecular weight (M_{w}) of the SRP may suitably range from about 1000 to about 20,000 and preferably ranges from about 1500 to about 10,000.

SRPs for use in the invention may suitably be selected from copolyesters of dicarboxylic acids (for example adipic acid, phthalic acid or terephthalic acid) with diols (for example ethylene glycol or propylene glycol) and polydiols (for example polyethylene glycol or polypropylene glycol). The copolyester may also include monomeric units substituted with anionic groups, such as for example sulfonated isophthaloyl units. Examples of such materials include oligomeric esters produced by transesterification/oligomerization of poly(ethyleneglycol) methyl ether, dimethyl terephthalate (“DMT”), propylene glycol (“PG”) and poly(ethyleneglycol) (“PEG”); partly- and fully-anionic-end-capped oligomeric esters such as oligomers from ethylene glycol (“EG”), PG, DMT and Na-3,6-dioxa-8-hydroxyoctanesulfonate; nonionic-capped block polyester oligomeric compounds such as those produced from DMT, Me-capped PEG and EG and/or PG, or a combination of DMT, EG and/or PG, Me-capped PEG and Na-dimethyl-5-sulfoisophthalate, and copolymeric blocks of ethylene terephthalate or propylene terephthalate with polyethylene oxide or polypropylene oxide terephthalate.

Other types of SRP for use in the invention include cellulosic derivatives such as hydroxyether cellulosic polymers, C₁-C₄ alkylcelluloses and C₄ hydroxyalkyl celluloses; polymers with poly(vinyl ester) hydrophobic segments such as graft copolymers of poly(vinyl ester), for example C₁-C₆ vinyl esters (such as poly(vinyl acetate)) grafted onto polyalkylene oxide backbones; poly(vinyl caprolactam) and related co-polymers with monomers such as vinyl pyrrolidone and/or dimethylaminoethyl methacrylate; and polyester-polyamide polymers prepared by condensing adipic acid, caprolactam, and polyethylene glycol.

Preferred SRPs for use in the invention include copolyesters formed by condensation of terephthalic acid ester and diol, preferably 1,2 propanediol, and further comprising an end cap formed from repeat units of alkylene oxide capped with an alkyl group. Examples of such materials have a structure corresponding to general formula (I):

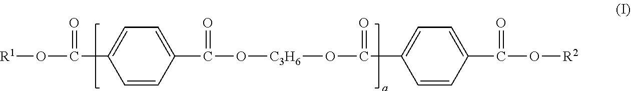

in which R¹ and R² independently of one another are X—(OC₂H₄)ₙ—(OC₃H₆)ₘ;

in which X is 01-4 alkyl and preferably methyl;

n is a number from 12 to 120, preferably from 40 to 50;

m is a number from 1 to 10, preferably from 1 to 7; and

a is a number from 4 to 9.

Because they are averages, m, n and a are not necessarily whole numbers for the polymer in bulk.

Mixtures of any of the above described materials may also be used.

SRP, when included, may be present in an amount ranging from 0.01 to 5%, more preferably from 0.02 to 1% (by weight based on the total weight of the composition) of one or more SRPs (such as, for example, the copolyesters of general formula (I) as are described above).

Anti-redeposition polymers stabilise the soil in the wash solution thus preventing redeposition of the soil. Suitable anti-redeposition polymers for use in the invention include alkoxylated polyethyleneimines. Polyethyleneimines are materials composed of ethylene imine units —CH2CH2NH— and, where branched, the hydrogen on the nitrogen is replaced by another chain of ethylene imine units. Preferred alkoxylated polyethylenimines for use in the invention have a polyethyleneimine backbone of about 300 to about 10000 weight average molecular weight (M_{w}). The polyethyleneimine backbone may be linear or branched. It may be branched to the extent that it is a dendrimer. The alkoxylation may typically be ethoxylation or propoxylation, or a mixture of both. Where a nitrogen atom is alkoxylated, a preferred average degree of alkoxylation is from 10 to 30, preferably from 15 to 25 alkoxy groups per modification. A preferred material is ethoxylated polyethyleneimine, with an average degree of ethoxylation being from 10 to 30, preferably from 15 to 25 ethoxy groups per ethoxylated nitrogen atom in the polyethyleneimine backbone. Another type of suitable anti-redeposition polymer for use in the invention includes cellulose esters and ethers, for example sodium carboxymethyl cellulose.

Mixtures of any of the above described materials may also be used.

Anti-redeposition polymer, when included, may be present in an amount ranging from 0.05 to 5%, more preferably from 0.1 to 3% (by weight based on the total weight of the composition).

A particularly preferred composition of the invention comprises, as the polymeric cleaning boosters:

from 0.2 to 1% (by weight based on the total weight of the composition) of SRP selected from copolyesters of dicarboxylic acids with diols and polydiols, and from 0.1 to 3% (by weight based on the total weight of the composition) of anti-redeposition polymer selected from ethoxylated polyethyleneimines with a polyethyleneimine backbone of 300 to 10000 weight average molecular weight (M_{w}) and an average degree of ethoxylation of from 15 to 25 ethoxy groups per ethoxylated nitrogen atom in the polyethyleneimine backbone.

When included, the total amount of polymeric cleaning boosters in a composition of the invention preferably ranges from 0.2 to 5%, more preferably from 0.5 to 4% (by weight based on the total weight of the composition).

A composition of the invention may suitably include one or more organic builders and/or sequestrants. Organic builders and/or sequestrants may help to enhance or maintain the cleaning efficiency of the composition, primarily by coordinating (i.e. binding) those metal ions which might otherwise interfere with cleaning action. Examples of such metal ions which are commonly found in wash water include divalent and trivalent metal ions such as ferrous, ferric, manganese, copper magnesium and calcium ions.

Suitable organic builders and/or sequestrants for use in the invention include phosphonates, in acid and/or salt form. When utilized in salt form, alkali metal (e.g. sodium and potassium) or alkanolammonium salts are preferred. Specific examples of such materials include aminotris(methylene phosphonic acid) (ATMP), 1-hydroxyethylidene diphosphonic acid (HEDP) and diethylenetriamine penta(methylene phosphonic acid (DTPMP) and their respective sodium or potassium salts.

Other types of organic builders and/or sequestrants for use in the invention include polycarboxylates, in acid and/or salt form. When utilized in salt form, alkali metal (e.g. sodium and potassium) or alkanolammonium salts are preferred. Specific examples of such materials include sodium and potassium citrates, sodium and potassium tartrates, the sodium and potassium salts of tartaric acid monosuccinate, the sodium and potassium salts of tartaric acid disuccinate, sodium and potassium ethylenediamine tetraacetates, sodium and potassium N(2-hydroxyethyl)-ethylenediamine triacetates, sodium and potassium nitrilotriacetates and sodium and potassium N-(2-hydroxyethyl)-nitrilodiacetates. Polymeric polycarboxylates may also be used, such as polymers of unsaturated monocarboxylic acids (e.g. acrylic, methacrylic, vinylacetic, and crotonic acids) and/or unsaturated dicarboxylic acids (e.g. maleic, fumaric, itaconic, mesaconic and citraconic acids and their anhydrides). Specific examples of such materials include polyacrylic acid, polymaleic acid, and copolymers of acrylic and maleic acid. The polymers may be in acid, salt or partially neutralised form and may suitably have a molecular weight (Mw) ranging from about 1,000 to 100,000, preferably from about 2,000 to about 85,000, and more preferably from about 2,500 to about 75,000. A preferred polycarboxylate sequestrant for use in the invention is citrate (in acid and/or salt form).

Mixtures of any of the above described materials may also be used.

Organic builders and/or sequestrants, when included, may be present in an amount ranging from about 0.01 to about 5%, more preferably from about 0.05 to about 2% (by weight based on the total weight of the composition).

The aqueous continuous phase of the composition of the invention includes from 0.05% to 2%, preferably from 0.1 to 1.5% and more preferably from 0.6 to 1.4% (by weight based on the total weight of the composition) of a first polymeric rheology modifier.

The first polymeric rheology modifier has a hydrophilic backbone including at least one hydrophobic segment which is available to form non-specific hydrophobic associations within the composition.

The hydrophilic backbone can be linear, branched, crosslinked or dendritic (i.e. a configuration where three branches are attached to a single atom such as a carbon atom). The hydrophilic character may be provided by monomers containing hydrophilic species such as hydroxyl or ionic groups.

Preferably, the first polymeric rheology modifier has an acrylic copolymer backbone prepared by the addition polymerization of a mixture of ethylenically unsaturated monomers, in which hydrophilic character is provided by the inclusion of anionic or anionisable monomers. Anionic or anionisable monomers may suitably be selected from C₃-C₈ monoethylenically unsaturated monocarboxylic acids; C₄-C₈ monoethylenically unsaturated dicarboxylic acids or anhydrides thereof; monoesters of monoethylenically unsaturated C₄-C₈ dicarboxylic acids with C₁-C₄ alkanols, and C₂-C₈ monoethylenically unsaturated sulfonic acids. In addition to or instead of these acids, it is also possible to use their salts, preferably their alkali metal or ammonium salts and more preferably their sodium salts.

Examples of anionic or anionisable monomers for use in the invention include (meth)acrylic acid (i.e. methacrylic acid and/or acrylic acid), crotonic acid, itaconic acid, fumaric acid, maleic acid, monomethyl itaconate, monomethyl fumarate, monobutyl fumarate, and maleic anhydride; and C₃-C₈ monoethylenically unsaturated sulfonic acids or salts thereof such as 2-acrylamido-2-methylpropanesulfonate (AMPS) or sodium vinyl sulfonate (SVS). Typically, the acrylic copolymer backbone will also include a proportion of nonionic monomers such as C₁-C₈ alkyl esters and C₂-C₈ hydroxyalkyl esters of acrylic acid or of methacrylic acid, for example ethyl acrylate, ethyl methacrylate, methyl methacrylate, 2-ethylhexyl acrylate, butyl acrylate, butyl methacrylate, 2-hydroxyethyl acrylate and 2-hydroxybutyl methacrylate.

Mixtures of any of the above described materials may also be used.

Preferably, the hydrophobic segments take the form of pendant hydrophobic groups which are covalently attached to the hydrophilic backbone and which extend from the hydrophilic backbone (so that they are available to form non-specific hydrophobic associations within the composition).

Preferred hydrophobic groups may be selected from linear or branched C₄-C₄₀ hydrocarbyl groups, more preferably linear or branched C₈-C₃₀ alkyl or aralkyl groups and most preferably linear C₁₂-C₂₂ alkyl groups.

Preferably the first polymeric rheology modifier comprises between 5 and 25% (by weight based on the total weight of the polymer) of the hydrophobic groups.

Mixtures of any of the above described materials may also be used.

Preferred first polymeric rheology modifiers for use in the invention include HASE polymers selected from linear or crosslinked copolymers that are prepared by the polymerization of a mixture of monomers comprising at least one anionic or anionisable monomer, such as (meth)acrylic acid (i.e. methacrylic acid and/or acrylic acid); and at least one hydrophobic monomer having an ethylenically unsaturated section (for addition polymerization with the other monomers in the mixture) and a hydrophobic section.

Preferably a poly(ethyleneoxy) section is interposed between the ethylenically unsaturated section and the hydrophobic section. The poly(ethyleneoxy) section is usually made up of a chain of from about 5 to about 100, preferably about 10 to about 80, and more preferably about 15 to about 60 ethylene oxide (EO) units

Particularly preferred first polymeric rheology modifiers for use in the invention include HASE polymers selected from linear or crosslinked copolymers that are prepared by the polymerization of a monomer mixture comprising (i) from 5 to 85%, more preferably from 25 to 70%, and most preferably from 35 to 65% (by weight based on the total weight of the monomer mixture) of nonionic monomers; (ii) from 5 to 85%, more preferably from 25 to 70%, and most preferably from 35 to 65% (by weight based on the total weight of the monomer mixture) of anionic or anionisable monomers; (iii) from 0.5 to 35%, more preferably from 1 to 25% (by weight based on the total weight of the monomer mixture) of hydrophobic monomers having an ethylenically unsaturated section (for addition polymerization with the other monomers in the mixture) and a hydrophobic section, and (iv) optionally, from 0.001 to 5%, preferably from 0.01 to 0.1% (by weight based on the total weight of the monomer mixture) of polyethylenically unsaturated copolymerizable monomers effective for crosslinking.

The nonionic monomers (i) are suitably selected from C₁-C₈ alkyl and C₂-C₈ hydroxyalkyl esters of acrylic and methacrylic acid. Preferred are ethyl acrylate, methyl acrylate, and butyl acrylate.

The anionic or anionisable monomers (ii) are suitably selected from acrylic acid, methacrylic acid, crotonic acid, 2-acrylamido-2-methyl-1-propanesulfonic acid, sodium vinyl sulfonate, itaconic acid, fumaric acid, maleic acid, monomethyl itaconate, monomethyl fumarate, monobutyl fumarate, and maleic anhydride. Preferred are acrylic acid and methacrylic acid.

In one suitable type of hydrophobic monomer (iii), the hydrophobic section is constituted by a homopolymeric, random copolymeric or block copolymeric chain formed from repeating units selected from C₁-C₂₂ alkyl acrylates, C₁-C₂₂alkyl methacrylates, methacrylic acid, acrylic acid or combinations thereof. Examples of such units include methyl methacrylate, ethyl methacrylate, butyl methacrylate, ethylhexyl methacrylate, stearylmethacrylate and mixtures thereof. One of the units at an end of the chain will remain available as an ethylenically unsaturated section for addition polymerisation with the other monomers in the mixture. Hydrophobic monomers of this type are usually referred to as “macromonomers” and may be prepared by catalytic chain transfer (CCT) procedures utilizing catalysts effective to achieve CCT such as the cobalt porphyrins and the cobaloximes. Macromonomers may advantageously have a number average molecular weight (Mₙ as determined by liquid permeation chromatography) ranging from about 200 to about 50,000, preferably from about 400 to about 10,000, and optimally from about 500 to about 3,000. Preferred examples of macromonomers include poly(methylmethacrylate)/poly(methacrylic acid), poly(methylmethacrylate), poly(butylmethacrylate), poly(ethylhexylmethacrylate) and combinations thereof.

Another suitable type of hydrophobic monomer (iii) includes a polyoxyalkylene section between the ethylenically unsaturated section and the hydrophobic section. Hydrophobic monomers of this type are sometimes referred to as “surfmers” and may typically be prepared by the acid catalyzed condensation of commercially available nonionic polyoxyalkylene surfactant alcohols with acrylic, methacrylic, crotonic, maleic, fumaric, itaconic or aconitic acid. Preferred examples of surfmers include C₈-C₃₀ alkylated polyethoxylated (meth) acrylates (i.e. methacrylates and/or acrylates) in which the polyethoxylated portion comprises about 5 to about 100, preferably about 10 to about 80, and more preferably about 15 to about 60 ethylene oxide (EO) units, such as C₁₈H₃₇(EO)₂₀ (meth)acrylate and C₁₂H₂₅(EO)₂₃ methacrylate.

The crosslinking comonomers (iv) are suitably selected from diallylphthalate, divinylbenzene, allyl methacrylate, trimethylol propane triacrylate, ethylene glycol diacrylate or dimethacrylate; 1,6-hexanediol diacrylate or dimethacrylate; and diallyl benzene.

Mixtures of any of the above described materials may also be used.

The first polymeric rheology modifier (such as, for example, a HASE polymer as is further described above) preferably has a weight average molecular weight (M_{w}) of about 30,000 g/mol to about 10,000,000 g/mol, for example about 30,000 to about 500,000 g/mol, more typically 50,000 g/mol to 500,000 g/mol. Molecular weight can be determined by physical properties such as intrinsic viscosity or by spectrophotometric analysis such as light scattering.

The composition of the invention has a dispersed phase of suspended benefit agent delivery particles; the particles having a core-shell structure in which a shell of polymeric material entraps a core containing the benefit agent.

The core of the benefit agent delivery particle is typically formed in an inner region of the particle and provides a sink for the benefit agent. The shell generally protects the benefit agent from the external environment and regulates the flow of benefit agent into and out of the core.

The shell is preferably of a generally spherical shape; and will typically comprise at most 20% by weight based on the total weight of the benefit agent delivery particle.

A benefit agent delivery particle for use in the invention will generally have an average particle size between 200 nanometers and 50 microns, more preferably from 350 nm to 30 microns and most preferably from 500 nm to 20 microns. The particle size distribution can be narrow, broad or multimodal. If necessary, the particles as initially produced may be filtered or screened to produce a product of greater size uniformity.

“Size” as used herein refers to diameter unless otherwise stated. For samples with particle diameter no greater than 1 micron, diameter means the z-average particle size measured, for example, using dynamic light scattering (as set out in international standard ISO 13321) with an instrument such as a Zetasizer Nano™ ZS90 (Malvern Instruments Ltd, UK). For samples with particle diameter greater than 1 micron, diameter means the apparent volume median diameter (D50), measurable for example, by laser diffraction (as set out in international standard ISO 13320) with an instrument such as a Mastersizer™ 2000 (Malvern Instruments Ltd, UK).

In a benefit agent delivery particle for use in the invention, the core contains a benefit agent. Preferred benefit agents in the context of fabric laundering include fragrance formulations, clays, enzymes, antifoams, fluorescers, bleaching agents and precursors thereof (including photo-bleach), dyes and/or pigments, conditioning agents (for example cationic surfactants including water-insoluble quaternary ammonium materials, fatty alcohols and/or silicones), lubricants (e.g. sugar polyesters), colour and photo-protective agents (including sunscreens), antioxidants, ceramides, reducing agents, sequestrants, colour care additives (including dye fixing agents), unsaturated oil, emollients, moisturizers, insect repellents and/or pheromones, drape modifiers (e.g. polymer latex particles such as PVAc) and antimicrobial or microbe control agents.

Mixtures of any of the above described materials may also be suitable. The most preferred benefit agents in the context of this invention are fragrance formulations.

Fragrance formulations for use in the invention will typically contain a blend of selected fragrant components, optionally mixed with one or more excipients. The combined odours of the various fragrant components produce a pleasant or desired fragrance.

The term “fragrant component” in the context of this invention denotes a material which is used essentially for its ability to impart a pleasant odour to a composition (into which it is incorporated), and/or a surface (to which it is applied), either on its own or in admixture with other such materials. Materials having these characteristics are generally small, lipophilic molecules of sufficient volatility to be transported to the olfactory system in the upper part of the nose.

Fragrant components for use in the invention will typically have molecular weights of less than 325 atomic mass units, preferably less than 300 atomic mass units and more preferably less than 275 atomic mass units. The molecular weight is preferably greater than 100 atomic mass units and more preferably greater than 125 atomic mass units, since lower masses may be too volatile and/or insufficiently lipophilic to be effective.

Fragrant components for use in the invention will preferably have a molecular structure which does not contain halogen atoms and/or strongly ionizing functional groups such as sulfonates, sulfates, or quaternary ammonium ions.

Fragrant components for use in the invention will more preferably have a molecular structure containing only atoms from among, but not necessarily all, of the following:

hydrogen, carbon, oxygen, nitrogen and sulphur. Most preferably the fragrant components will have a molecular structure containing only atoms from among, but not necessarily all, of the following: hydrogen, carbon and oxygen.

Examples of fragrant components include aromatic, aliphatic and araliphatic hydrocarbons having molecular weights from about 90 to about 250; aromatic, aliphatic and araliphatic esters having molecular weights from about 130 to about 250; aromatic, aliphatic and araliphatic nitriles having molecular weights from about 90 to about 250; aromatic, aliphatic and araliphatic alcohols having molecular weights from about 90 to about 240; aromatic, aliphatic and araliphatic ketones having molecular weights from about 150 to about 270; aromatic, aliphatic and araliphatic lactones having molecular weights from about 130 to about 290; aromatic, aliphatic and araliphatic aldehydes having molecular weights from about 90 to about 230; aromatic, aliphatic and araliphatic ethers having molecular weights from about 150 to about 270; and condensation products of aldehydes and amines having molecular weights from about 180 to about 320.

Naturally occurring exudates such as essential oils extracted from plants may also be used as fragrant components in the invention. Essential oils are usually extracted by processes of steam distillation, solid-phase extraction, cold pressing, solvent extraction, supercritical fluid extraction, hydrodistillation or simultaneous distillation-extraction.

Essential oils may be derived from several different parts of the plant, including for example leaves, flowers, roots, buds, twigs, rhizomes, heartwood, bark, resin, seeds and fruits. The major plant families from which essential oils are extracted include Asteraceae, Myrtaceae, Lauraceae, Lamiaceae, Myrtaceae, Rutaceae and Zingiberaceae. The oil is “essential” in the sense that it carries a distinctive scent, or essence, of the plant.

Essential oils are understood by those skilled in the art to be complex mixtures which generally consist of several tens or hundreds of constituents. Most of these constituents possess an isoprenoid skeleton with 10 atoms of carbon (monoterpenes), 15 atoms of carbon (sesquiterpenes) or 20 atoms of carbon (diterpenes). Lesser quantities of other constituents can also be found, such as alcohols, aldehydes, esters and phenols. However, an individual essential oil is usually considered as a single ingredient in the context of practical fragrance formulation. Therefore, an individual essential oil may be considered as a single fragrant component for the purposes of this invention.

The number of different fragrant components contained in the fragrance formulation will generally be at least 4, preferably at least 6, more preferably at least 8 and most preferably at least 10, such as from 10 to 200 and more preferably from 10 to 100.

Typically, no single fragrant component will comprise more than 70% by weight of the total weight of the fragrance formulation. Preferably no single fragrant component will comprise more than 60% by weight of the total weight of the fragrance formulation and more preferably no single fragrant component will comprise more than 50% by weight of the total weight of the fragrance formulation.

The term “fragrance formulation” in the context of this invention denotes the fragrant components as defined above, plus any optional excipients. Excipients may be included within fragrance formulations for various purposes, for example as solvents for insoluble or poorly-soluble components, as diluents for the more potent components or to control the vapour pressure and evaporation characteristics of the fragrance formulation. Excipients may have many of the characteristics of fragrant components, but they do not have strong odours in themselves. Accordingly, excipients may be distinguished from fragrant components because they can be added to fragrance formulations in high proportions such as 30% or even 50% by weight of the total weight of the fragrance formulation without significantly changing the odour quality of the fragrance formulation. Some examples of suitable excipients include ethanol, isopropanol, diethylene glycol monoethyl ether, dipropylene glycol, diethyl phthalate and triethyl citrate. Mixtures of any of the above described materials may also be suitable.

A suitable fragrance formulation for use in the invention comprises a blend of at least 10 fragrant components selected from hydrocarbons; aliphatic and araliphatic alcohols; aliphatic aldehydes and their acetals; aliphatic carboxylic acids and esters thereof; acyclic terpene alcohols; cyclic terpene aldehydes and ketones; cyclic and cycloaliphatic ethers; esters of cyclic alcohols; esters of araliphatic alcohols and aliphatic carboxylic acids;

araliphatic ethers and their acetals; aromatic and araliphatic aldehydes and ketones and aromatic and araliphatic carboxylic acids and esters thereof; as are further described above.

The content of fragrant components preferably ranges from 50 to 100%, more preferably from 60 to 100% and most preferably from 75 to 100% by weight based on the total weight of the fragrance formulation; with one or more excipients (as described above) making up the balance of the fragrance formulation as necessary.

The fragrance formulation will typically comprise from about 10 to about 60% and preferably from about 20 to about 40% by weight based on the total weight of the benefit agent delivery particle.

In a benefit agent delivery particle for use in the invention, a second polymeric rheology modifier is covalently attached to the exterior surface of the shell of the delivery particle (either directly or via a linking group).

A benefit agent delivery particle for use in the invention may be prepared in a method which typically involves two stages—a first stage in which particles having a core-shell structure are prepared; and a second stage in which the second polymeric rheology modifier is attached.

In the first stage, particles having a core-shell structure may be prepared using methods known to those skilled in the art such as coacervation, interfacial polymerization, and polycondensation.

The process of coacervation typically involves encapsulation of a generally water-insoluble core material by the precipitation of colloidal material(s) onto the surface of droplets of the material. Coacervation may be simple e.g. using one colloid such as gelatin, or complex where two or possibly more colloids of opposite charge, such as gelatin and gum arabic or gelatin and carboxymethyl cellulose, are used under carefully controlled conditions of pH, temperature and concentration.

Interfacial polymerisation typically proceeds with the formation of a fine dispersion of oil droplets (the oil droplets containing the core material) in an aqueous continuous phase. The dispersed droplets form the core of the future particle and the dimensions of the dispersed droplets directly determine the size of the future particle. Shell-forming materials (monomers or oligomers) are contained in both the dispersed phase (oil droplets) and the aqueous continuous phase and they react together at the phase interface to build a polymeric wall around the oil droplets thereby to encapsulate the droplets. An example of a particle produced by this method has a polyurea shell formed by reaction of diisocyanates or polyisocyanates with diamines or polyamines.

Polycondensation involves forming a dispersion or emulsion of the core material in an aqueous solution of precondensate of polymeric materials under appropriate conditions of agitation to produce dispersed core material of a desired particle size and adjusting the reaction conditions to cause condensation of the precondensate by acid catalysis, resulting in the condensate separating from solution and surrounding the dispersed core material to produce a coherent film and the desired particles. An example of a particle produced by this method has an aminoplast shell formed from the polycondensation product of melamine (2,4,6-triamino-1,3,5-triazine) or urea with formaldehyde. Suitable cross-linking agents (e.g. toluene diisocyanate, divinyl benzene, butanediol diacrylate) may also be used and secondary wall polymers may also be used as appropriate, e.g. anhydrides and their derivatives, particularly polymers and co-polymers of maleic anhydride.

In a benefit agent delivery particle for use in the invention, the shell of polymeric material is preferably an aminoplast shell formed from the polycondensation product of melamine with formaldehyde.

Following completion of the first stage, the second polymeric rheology modifier may be attached using a coupling agent such as EDAC. Alternatively, the second polymeric rheology modifier may be admixed with a further quantity of shell-forming monomers (such as melamine and formaldehyde) and added to the core-shell particles. This adds an exterior layer to the shell incorporating the second polymeric rheology modifier. For second polymeric rheology modifiers which have a low cloud point (e.g. less than 60° C.), an anionic surfactant such as ethoxylated sodium laurylether sulfate will suitably be included in the exterior layer-forming mixture which is added to the core-shell particles.

The second polymeric rheology modifier will typically comprise from about 0.1 to about 5% by weight based on the total weight of the benefit agent delivery particle.

The second polymeric rheology modifier has a hydrophilic backbone including at least one hydrophobic segment which is available to form non-specific hydrophobic associations within the composition.

Preferably, the second polymeric rheology modifier has a hydrophilic polysaccharide backbone. Examples of hydrophilic polysaccharide backbones are water-soluble nonionic polysaccharides such as cellulose ethers. Examples of cellulose ethers are hydroxyethylcellulose (HEC), hydroxypropylcellulose (HPC), methylcellulose (MC), hydroxypropylmethylcellulose (HPMC), ethylhydroxyethylcellulose (EHEC), and methylhydroxyethylcellulose (MHEC). HEC and EH EC are preferred.

Generally, in the process of making cellulose ethers, purified cellulose, derived from wood, cotton, or related scrap materials, is converted to “alkali cellulose” and then reacted with an etherifying reagent such as ethylene oxide. The reaction of ethylene oxide with cellulose occurs with one of the glucose residue hydroxyls and in turn produces a new hydroxyl from the ring opening reaction of the ethylene oxide. Therefore, as the reaction continues, further substitution can occur directly on the glucose residue or at the terminal hydroxyl for a previously reacted ethylene oxide. As a consequence, short poly(ethylene oxide) side chains (usually two or three units in length) result. The term “molar substitution” (MS) describes the average number of moles of ethylene oxide that have attached to each anhydroglucose unit, and typically ranges from 0.5 to 4.0. If a mixed ether such as ethylhydroxyethylcellulose is to be produced, the two reagents (ethyl chloride and ethylene oxide) can be added either consecutively or as a mixture. The ethyl chloride reacts with the hydroxyl groups of the polymer and does not create any new hydroxyl groups in the process (unlike the reaction with ethylene oxide). The term “degree of ethyl substitution” (DS_{ethyl}) refers to the average number of hydroxyl groups per anhydroglucose unit which have been substituted with the ethyl group, and typically ranges from 0.3 to 1.2.

The hydrophobic segments of the second polymeric rheology modifier typically take the form of pendant hydrophobic groups which are covalently attached to the hydrophilic backbone and which extend from the hydrophilic backbone (so that they are available to form non-specific hydrophobic associations within the composition). The pendant hydrophobic groups are preferably attached to the hydrophilic backbone by ether linkages. Suitable pendant hydrophobic groups may be selected from monovalent linear or branched C₄-C₃₀ hydrocarbyl groups, more preferably linear or branched C₈-C₂₂ alkyl or alkenyl groups and most preferably linear C₁₂-C₁₆ alkyl groups.

The second polymeric rheology modifier will typically comprise from about 0.01 to about 2%, preferably from about 0.3 to about 0.8% (by weight based on the total weight of the second polymeric rheology modifier) of hydrophobic segments such as the pendant hydrophobic groups described above.

The second polymeric rheology modifier (such as, for example, a hydrophobically-modified cellulose ether as is further described above) preferably has a weight average molecular weight (M_{w}) of about 30,000 g/mol to about 10,000,000 g/mol, for example about 30,000 to about 2,000,000 g/mol, more typically 50,000 g/mol to 1,500,000 g/mol.

The second polymeric rheology modifier may also be selected from any of the first polymeric rheology modifiers described above (such as HASE polymers), or mixtures thereof.

The first and second polymeric rheology modifiers may be the same or different.

Mixtures of any of the above described materials may also be used.

In a typical laundry treatment composition according to the invention the level of benefit agent delivery particles will generally range from 0.01 to 10%, preferably from 0.1 to 5%, more preferably from 0.3 to 3% (by weight based on the total weight of the composition).

The present inventors have surprisingly found that the composition of the invention is effectively stabilized and provides sufficient rheological benefits, such as particle suspension and shear thinning capabilities, without requiring the inclusion of additional structuring agents other than those described above.

Accordingly, the composition of the invention generally includes no more than 0.5%, preferably no more than 0.2%, and more preferably no more than 0.1% (by weight based on the total weight of the composition) of additional structuring agents. Most preferably the composition of the invention is essentially free of additional structuring agents. The term “essentially free of” in the context of this invention denotes that the indicated material is not deliberately added to the composition, or preferably not present at analytically detectable levels. It may include compositions in which the indicated material is present only as an impurity of one of the other materials deliberately added.

Typical “additional structuring agents” in the context of this invention include fibre-based or crystalline materials which, when incorporated into a composition, form a physical network that reduces the tendency of the compositional components to coalesce and/or phase split.

Specific examples of fibre-based structuring agents include cellulose fibrils. Cellulose fibrils can be derived from any suitable source, including wood sources such as spruce, pine, bamboo and eucalyptus, or vegetable and plant sources such as citrus fruit, sugar beet, flax and hemp. The individual fibrils will typically have lateral dimensions from 1 to 100, preferably 5 to 20 nanometres, longitudinal dimensions ranging from nanometres to several microns and an average aspect ratio (I/d) of from 50 to 200,000, more preferably from 100 to 10,000.

Specific examples of crystalline structuring agents include crystallizable glycerides having a melting point of from 40° C. to 100° C., such as hydrogenated castor oil (“HCO”). Castor oils may include glycerides, especially triglycerides, comprising C₁₀ to C₂₂ alkyl or alkenyl groups which incorporate a hydroxyl group. Hydrogenation of castor oil, to make HCO, converts the unsaturated groups which may be present in the starting oil (e.g. ricinoleyl groups) into saturated hydroxyalkyl groups such as hydroxystearyl.

Most preferably the composition of the invention is essentially free of additional structuring agents selected from fibre-based structuring agents (as described above) and/or crystalline structuring agents (as described above).

A laundry treatment composition of the invention may be packaged as unit doses in polymeric film soluble in the wash water. Alternatively, a composition of the invention may be supplied in multidose plastics packs with a top or bottom closure. A dosing measure may be supplied with the pack either as a part of the cap or as an integrated system.

A method of treating fabric using a laundry detergent according to the invention will usually involve diluting the dose of detergent to obtain a wash liquor and washing fabrics with the wash liquor so formed. The method of laundering fabric may suitably be carried out in an automatic washing machine or can be carried out by hand.

In automatic washing machines, the dose of detergent is typically put into a dispenser and from there it is flushed into the machine by the water flowing into the machine, thereby forming the wash liquor. Alternatively, the dose of detergent may be added directly into the drum. Dosages for a typical front-loading washing machine (using 10 to 15 litres of water to form the wash liquor) may range from about 10 ml to about 60 ml, preferably about 15 to 40 ml. Dosages for a typical top-loading washing machine (using from 40 to 60 litres of water to form the wash liquor) may be higher, e.g. up to about 100 ml. Lower dosages of detergent (e.g. 50 ml or less) may be used for hand washing methods (using about 1 to 10 litres of water to form the wash liquor). A subsequent aqueous rinse step and drying the laundry is preferred. Any input of water during any optional rinsing step(s) is not included when determining the volume of the wash liquor.

The laundry drying step can take place either in an automatic dryer or in the open air.

The invention will now be further described with reference to the following non-limiting Examples.

### EXAMPLES

### Example 1: Attachment of a HM-Polysaccharide onto Perfume Encapsulates Via Melamine-Formaldehyde (MF) Shell Formation

The pre-formed melamine formaldehyde perfume encapsulates were 5 micron in size and obtained from International Flavours and Fragrances (IFF) Limited. The particle solids were 37.2 wt % and perfume solids were 28 wt % respectively. The HM-polysaccharides utilized were:

Natrosol® Plus 330: cetyl modified hydroxyethylcellulose (HM-HEC) from Ashland

PolySurf® 67: cetyl modified hydroxyethylcellulose (HM-HEC) from Ashland

Bermocoll® EHM200, EHM300 and EHM500: (C₁₂-C₁₆)-modified ethyl hydroxyethyl cellulose (HM-EHEC) from Akzo Nobel.

The following procedure outlines the synthetic modification to attach the HM-polysaccharide to the surface via the formation of additional melamine formaldehyde (MF) shell:

1. Pre-Polymer Preparation

To a 100 ml conical flask was add 19.5 g formalin (37 wt % aqueous formaldehyde) and 44 g water. The pH of the solution was adjusted to 8.9 using 0.7 g of 5 wt % aqueous sodium carbonate. 10 g of melamine and 0.64 g of sodium chloride was added, and the mixture stirred for 10 minutes at room temperature. The mixture was heated to 62° C. and stirred until it became clear. This mixture is referred to as “pre-polymer(1)”.

2. HM-Polysaccharide Attachment to Pre-Formed Melamine Formaldehyde Perfume Encapsulates:

0.2 g of PolySurf® 67 was dissolved in 74.7 g deionized water by shaking overnight on an orbital shaker and then transferred to a 250 ml round bottomed flask fitted with overhead stirrer and condenser. 25.3 g of melamine formaldehyde encapsulate slurry (37.7 wt % particle solids) was added and the mixture heated to 75° C. with stirring. 0.9 g of a freshly prepared pre-polymer(1) solution was added and the pH adjusted to 4.1, using 2 g of 10 wt % formic acid aqueous solution. The mixture was then left to stir, at 75° C. for 2 hours. The solution was then adjusted to pH 7 using 7.5 g of 5 wt % sodium carbonate aqueous solution. A final dispersion (100 g) consisting of 10 wt % encapsulate solids containing an additional 2 wt % melamine formaldehyde shell and 2 wt % (based on final particle weight) of PolySurf® 67 was obtained.

### Example 2: Attachment of a HASE Polymer onto Perfume Encapsulates Via Melamine-Formaldehyde Shell Formation

The process described in Example 1 was followed, with xyloglucan (Glyloid 3S from DSP Gokyo Food & Chemical) substituted for the PolySurf® 67. On completion, 0.67 g of CrystaSense Sapphire (HASE polymer from Croda) was added, along with 0.027 g EDAC. The solution was then shaken for 4 hours at room temperature.

### Example 3: Preparation of a Laundry Detergent Containing a HASE-Rheology Modifier and Modified Capsule

Liquid laundry detergent formulations were prepared by sequential mixing of the ingredients as shown in Table 1. Example A is a comparative example (not according to the invention) and Examples 1 to 4 are examples according to the invention.

TABLE 1

| | Example | | | | |
|---|---|---|---|---|---|
| | A | 1 | 2 | 3 | 4 |
| Ingredient | wt. % (active ingredient) | | | | |
| NaOH | 0.22 | 0.22 | 0.22 | 0.22 | 0.22 |
| TEA | 4.50 | 4.50 | 4.50 | 4.50 | 4.50 |
| Citric Acid | 0.18 | 0.18 | 0.18 | 0.18 | 0.18 |
| LAS acid | 2.00 | 2.00 | 2.00 | 2.00 | 2.00 |
| EPEI | 0.75 | 0.75 | 0.75 | 0.75 | 0.75 |
| SRP | 0.10 | 0.10 | 0.10 | 0.10 | 0.10 |
| SLES 3EO | 6.00 | 6.00 | 6.00 | 6.00 | 6.00 |
| BIT | 0.02 | 0.02 | 0.02 | 0.02 | 0.02 |
| MIT | 0.01 | 0.01 | 0.01 | 0.01 | 0.01 |
| Acusol ® Millennium | 1.10 | 1.10 | 1.10 | 1.10 | 1.10 |
| Microcapsule⁽¹⁾ | 0.60 | — | — | — | — |
| Microcapsule⁽²⁾ | — | 0.60 | — | — | — |
| Microcapsule⁽³⁾ | — | — | 0.60 | — | — |
| Microcapsule⁽⁴⁾ | — | — | — | 0.60 | — |
| Microcapsule⁽⁵⁾ | — | — | — | — | 0.60 |

| | |
|---|---|
| Demineralised water | q.s. to 100 |

⁽¹⁾13.5-micron diameter core-shell microcapsules with melamine-formaldehyde shell
⁽²⁾13.5-micron diameter core-shell microcapsules with melamine-formaldehyde shell; exterior shell surface modified with 2.0% (by weight based on total weight of microcapsule) PolySurf ® 67
⁽³⁾13.0-micron diameter core-shell microcapsules with melamine-formaldehyde shell; exterior shell surface modified with 2.0% (by weight based on total weight of microcapsule) Bermocoll ® EHM200
⁽⁴⁾13.2-micron diameter core-shell microcapsules with melamine-formaldehyde shell; exterior shell surface modified with 2.0% (by weight based on total weight of microcapsule) Bermocoll ® EHM300
⁽⁵⁾16.5-micron diameter core-shell microcapsules with melamine-formaldehyde shell; exterior shell surface modified with 2.0% (by weight based on total weight of microcapsule) Bermocoll ® EHM500

Samples of the above formulations were evaluated for stability using a LUMiSizer (LUM GmbH) dispersion analyser. The LUMiSizer is an analytical centrifuge that instantaneously measures the extinction (space- and time-resolved) of the transmitted light across the entire length of a sample using the STEP-Technology. Using an enhanced optical system, the LUMiSizer can analyse particle and droplet velocity distributions for creaming and sedimentation. By varying the speed and temperature, the creaming process can be accelerated and quantified.

The stability of a sample is expressed as an instability index (II), where 1 represents complete instability and 0 indicates complete stability.

All samples were tested using the following protocol: 8 hours at 37° C., 829 rpm (equivalent to 100×G). Sample tube—2 mm path length polycarbonate.

Sample formulations were prepared and rolled for 12 hours prior to measurement.

Results

The results are shown in Table 2.

TABLE 2

| | Example | Example | Example | Example | Example |
|---|---|---|---|---|---|
| Formulation | A | 1 | 2 | 3 | 4 |
| Instability Index | 0.336 | 0.185 | 0.016 | 0.011 | 0.016 |

It can be seen from a comparison of Examples 1 to 4 with Example A that modification of the exterior shell surface of the microcapsule with HM-polysaccharides imparts improved stability in formulations which are thickened with a hydrophobically-modified rheology modifier.

1. A liquid laundry detergent composition having:
(i) an aqueous continuous phase including from 3 to 80% (by weight based on the total weight of the composition) of one or more detersive surfactants and from 0.05% to 2% (by weight based on the total weight of the composition) of a first polymeric rheology modifier; and
(ii) a dispersed phase of suspended benefit agent delivery particles; the particles having a core-shell structure in which a shell of polymeric material entraps a core containing the benefit agent;
in which a second polymeric rheology modifier comprises a hydrophilic polysaccharide backbone and is covalently attached to the exterior surface of the shell of the delivery particle (either directly or via a linking group);
and in which the first and the second polymeric rheology modifiers each have a hydrophilic backbone including at least one hydrophobic segment so that it/they is/are available to form non-specific hydrophobic associations within the composition
wherein the second polymeric rheology modifier has a hydrophilic polysaccharide backbone selected from hydroxyethylcellulose (HEC), hydroxypropylcellulose (HPC), methylcellulose (MC), hydroxypropylmethylcellulose (HPMC), ethylhydroxyethylcellulose (EHEC), and methylhydroxyethylcellulose (MHEC); and the hydrophilic polysaccharide backbone is selected from HEC having a molar substitution (MS) ranging from 0.5 to 4.0; and EHEC having an MS ranging from 0.5 to 4.0 and a degree of ethyl substitution (DS_{ethyl}) ranging from 0.3 to 1.2; and in which pendant hydrophobic groups selected from linear C₁₂-C₁₆ alkyl groups are attached to the hydrophilic backbone by ether linkages.

2. A composition according to claim 1, in which the first polymeric rheology modifier has an acrylic copolymer backbone prepared by the addition polymerization of a mixture of ethylenically unsaturated monomers, in which hydrophilic character is provided by the inclusion of anionic or anionisable monomers.

3. A composition according to claim 2, in which the first polymeric rheology modifiers is a HASE polymer selected from linear or crosslinked copolymers that are prepared by the polymerization of a monomer mixture comprising (i) from 35 to 65% (by weight based on the total weight of the monomer mixture) of nonionic monomers; (ii) from 35 to 65% (by weight based on the total weight of the monomer mixture) of anionic or anionisable monomers; (iii) from 1 to 25% (by weight based on the total weight of the monomer mixture) of hydrophobic monomers having an ethylenically unsaturated section (for addition polymerization with the other monomers in the mixture) and a hydrophobic section, and (iv) optionally, from 0.01 to 0.1% (by weight based on the total weight of the monomer mixture) of polyethylenically unsaturated copolymerizable monomers effective for crosslinking.

4. A composition according to claim 3, in which the nonionic monomers (i) are selected from ethyl acrylate, methyl acrylate, and butyl acrylate; the anionic or anionisable monomers (ii) are selected from acrylic acid and methacrylic acid, and the hydrophobic monomers (iii) are selected from C₈-C₃₀ alkylated polyethoxylated (meth) acrylates in which the polyethoxylated portion comprises from 15 to 60 ethylene oxide (EO) units.

5. A composition according to claim 1, in which the benefit agent is a fragrance formulation and the fragrance formulation comprises from 20 to 40% by weight based on the total weight of the benefit agent delivery particle.

6. A composition according to claim 1, in which the shell of polymeric material is an aminoplast shell formed from the polycondensation product of melamine with formaldehyde.

7.-9. (canceled)

10. A composition according to claim 1 which is essentially free of additional structuring agents selected from fibre-based structuring agents and/or crystalline structuring agents.
